(19) United States
(12) Patent Application Publication
(10) Pub. No.: US 2026/0186289 A1
(43) Pub. Date: Jul. 2, 2026

(54) APPARATUS AND METHOD OF OBTAINING AN IMAGE OF A SAMPLE DURING NONUNIFORM MOVEMENTS

(71) Applicant: Illumina, Inc., San Diego, CA (US)

(72) Inventors: Merek SIU, San Diego, CA (US); Steven Boege, San Diego, CA (US); Danilo Condello, San Diego, CA (US); Simon Prince, San Diego, CA (US); Anthony Lam, San Diego, CA (US)

(21) Appl. No.: 18/865,322

(22) PCT Filed: May 1, 2023
(86) PCT No.: PCT/US2023/020550

§ 371 Date: Nov. 12, 2024

Related U.S. Application Data
(60) Provisional application No. 63/341,455, filed on May 13, 2022.

(51) Int. Cl. G02B 21/26; G02B 21/00

(52) U.S. Cl. CPC G02B 21/26; G02B 21/0036; G02B 21/0052

(57) ABSTRACT

A method is used to image a sample while it is undergoing non-uniform movement. While the sample is in motion, the field of view of a camera used to image the sample is illuminated. The intensity of the illumination may be modulated such that the dose per unit length of a sample container may remain constant even as the period during which any particular feature of the sample container is in the field of view of the camera may vary due to movement non-uniformity.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

For objects to be imaged, photons must be collected while the objects are in the field of view of an imaging device. This, in turn, requires the objects to be illuminated. To ensure consistent data collection, the energy applied through illumination during the time each object is in the field of view should be uniform. High precision motion stages, time delay integration (TDI) cameras, and diode pumped solid state (DPSS) lasers are among the components that have been used to achieve this objective.

### SUMMARY

Examples disclosed herein are directed to techniques for illumination of objects, and focuses particularly on techniques for illumination of samples of genetic material to be sequenced.

An implementation relates to a machine comprising a stage, a camera to capture images, and an actuation system to move the stage relative to a field of view of the camera which overlaps the stage. Such a machine may also comprise a controller to generate a set of analysis signals for features of a sample container on the stage, wherein each of the analysis signals has a uniform response profile, by performing acts comprising a set of non-uniform movement imaging acts. The set of non-uniform movement imaging acts may comprise, during a first period, accelerating the stage relative to the field of view of the camera from a first speed to a second speed, and illuminating the field of view of the camera at a first average intensity. The set of non-uniform movement imaging acts may comprise, during a second period which follows the first period, moving the stage relative to the field of view of the camera at a predetermined, substantially constant scanning speed, and illuminating the field of view of the camera at a second intensity, the second intensity being substantially constant, wherein the predetermined scanning speed is greater than or equal to the second speed. The set of non-uniform movement imaging acts may comprise, during a third period which follows the second period, decelerating the stage relative to the field of view of the camera from a third speed to a fourth speed, and illuminating the field of view of the camera at a third average intensity, wherein the third speed is less than or equal to the predetermined scanning speed. The set of non-uniform movement imaging acts may comprise capturing exposures of features of the sample container on the stage during the first period, the second period, and the third period.

In some implementations of a machine such as described in the preceding paragraph of this summary, the controller is to illuminate the field of view of the camera at the first average intensity during the first period, the second intensity during the second period, and the third average intensity during the third period by performing acts comprising providing a motion profile for the stage to an illumination controller, wherein the illumination controller is to provide the uniform response profile for each of the analysis signals by continuously modulating intensity of the illumination source based on velocity of the stage when the stage is accelerating relative to the field of view of the camera and when the stage is decelerating relative to the field of view of the camera.

In some implementations of a machine such as described in the second paragraph of this summary, the machine may comprise an illumination controller to control the illumination source, and an encoder to provide measurements of a position of the stage. In some implementations of such a machine, the controller is to illuminate the field of view of the camera at the first average intensity during the first period by performing acts comprising synchronizing measurements of the position of the stage from the encoder with the illumination controller.

In some implementations of a machine such as described in the second paragraph of this summary, the first average intensity, the second intensity and the third average intensity may all be equal. In some implementations of such a machine, the controller is to generate the set of analysis signals by performing acts comprising, for each exposure of features of the sample container on the stage, normalizing data from that exposure based on a speed of the stage when that exposure is captured.

In some implementations of a machine such as described in any of the second through fifth paragraphs of this summary, the actuation system may be a motor, and the camera may be a time delay integration (TDI) line scan camera. In some implementations of such a machine, the illumination source may be selected from a group consisting of a diode laser and a light emitting diode.

In some implementations of a machine such as described in any of the second through sixth paragraphs of this summary, the first period may comprise an acceleration period during which the controller is to accelerate the stage relative to the field of view of the camera from immobility to the predetermined scanning speed. In some implementations of such a machine, the third period may comprise a deceleration period during which the controller is to decelerate the stage relative to the field of view of the camera from the predetermined scanning speed to immobility. In some implementations of such a machine, the controller may perform the set of non-uniform movement imaging acts a plurality of times, with each performance of the set of non-uniform movement imaging acts corresponding to a swath of features of the sample container. In some implementations of such a machine, during each performance of the set of non-uniform movement imaging acts, the controller is to move the stage relative to the field of view of the camera in a scanning direction. In some implementations of such a machine, the controller is to, between any two consecutive performances of the set of non-uniform imaging acts, move from a swath corresponding to a first performance from the two consecutive performances to a swath corresponding to a second performance from the two consecutive performances by moving the stage in a direction oblique to the scanning direction.

In some implementations of a machine such as described in any of the second through seventh paragraphs of this summary, the controller may focus the camera, during the second period, based on exposures of features of the sample container on the stage captured at the end of the first period.

In some implementations of a machine such as described in any of the second through eighth paragraphs of this summary, a product of the first average intensity and an average speed during the first period is equal to a product of the predetermined scanning speed and the second average intensity. In some such implementations, a product of the third average intensity and an average speed during the third period is equal to the product of the predetermined scanning speed and the second average intensity.

In some implementations of a machine such as described in any of the second through ninth paragraphs of this summary, the first period is comprised by an acceleration period during which the controller is to accelerate the stage relative to the field of view of the camera from immobility to the predetermined scanning speed. In some such implementations, the set of non-uniform movement imaging acts comprises illuminating the field of view of the camera at the first average intensity during the first period by providing the illumination source current continuously during the acceleration period at levels which vary with speed of the stage during the acceleration period.

In some implementations of a machine such as described in any of the second through ninth paragraphs of this summary, the first period is comprised by an acceleration period during which the controller is to accelerate the stage relative to the field of view of the camera from immobility to the predetermined scanning speed. In some such implementations, the set of non-uniform movement imaging acts comprises illuminating the field of view of the camera at the first average intensity during the first period by providing the illumination source current in pulses at a rate which varies with speed of the stage during the acceleration period.

Another implementation relates to a method comprising generating a set of analysis signals for features of a sample container, wherein each of the analysis signals has a uniform response profile, by performing a set of non-uniform movement imaging acts. In some such implementations, the set of non-uniform movement imaging acts may comprise, during a first period, accelerating a stage relative to a field of view of a camera from a first speed to a second speed, and illuminating the field of view of the camera at a first average intensity. In some implementations of such a method, the set of non-uniform movement imaging acts further comprise, during a second period which follows the first period, moving the stage relative to the field of view of the camera at a predetermined scanning speed, and illuminating the field of view of the camera at a second average intensity, wherein the predetermined scanning speed is greater than or equal to the second speed. In some implementations of such a method, the set of non-uniform movement imaging acts further comprise, during a third period which follows the second period, decelerating the stage relative to the field of view of the camera from a third speed to a fourth speed, and illuminating the field of view of the camera at a third average intensity, wherein the third speed is less than or equal to the predetermined scanning speed. In some implementations of such a method, the set of non-uniform movement imaging acts further comprise capturing exposures of features of the sample container on the stage during the first period, the second period, and the third period.

In some implementations of a method such as described in the preceding paragraph, the method further comprises providing a motion profile for the stage a controller which controls an illumination source to illuminate the field of view of the camera. In some such implementations, the method may further comprise the controller which controls the illumination source providing the uniform response profile for each of the analysis signals by continuously modulating intensity of the illumination source based on speed of the stage when the stage is accelerating relative to the field of view of the camera and when the stage is decelerating relative to the field of view of the camera.

In some implementations of a method such as described in the twelfth paragraph of this summary, the method further comprises measuring a position of the stage using an encoder during periods comprising the first period and the third period. In some implementations of such a method, illuminating the field of view of the camera at the first and third intensities during the first and third periods is based on providing measurements of the position of the stage from the encoder to a controller which controls an illumination source and modulates illumination intensity based on measurements of the position of the stage from the encoder.

In some implementations of a method such as described in the twelfth paragraph of this summary, the first average intensity, the second average intensity and the third average intensity are all equal. In some such implementations, the method comprises generating the set of analysis signals by performing acts comprising, for each exposure of features of the sample container on the stage, normalizing data from that exposure based on a speed of the stage when that exposure is captured.

In some implementations of a method such as described in any of the twelfth through fifteenth paragraphs of this summary, the camera is a time delay integration (TDI) line scan camera. In some implementations of such a method, illuminating the field of view of the camera during the first period, the second period and the third period is performed using an illumination source selected from a group consisting of a diode laser and a light emitting diode.

In some implementations of a method such as described in any of the twelfth through sixteenth paragraphs of this summary, the first period is comprised by an acceleration period during which the stage is accelerated relative to the field of view of the camera from immobility to the predetermined scanning speed. In some such implementations, the third period is comprised by a deceleration period during which the stage is decelerated relative to the field of view of the camera from the predetermined scanning speed to immobility. In some such implementations, the method comprises performing the set of non-uniform movement imaging acts a plurality of times, with each performance of the set of non-uniform movement imaging acts corresponding to a swath of features on the sample container. In some implementations of such a method, during each performance of the set of non-uniform movement imaging acts, the stage is moving relative to the field of view of the camera in a scanning direction. In some implementations of such a method, the method comprises, between any two consecutive performances of the set of non-uniform movement imaging acts, moving from a swath corresponding to a first performance from the two consecutive performances to a swath corresponding to a second performance from the two consecutive performances by moving the stage in a direction oblique to the scanning direction.

In some implementations of a method such as described in any of the twelfth through seventeenth paragraphs of this summary, the method comprises focusing the camera based on exposures of features of the sample container on the stage captured during the first period.

In some implementations of a method such as described in any of the twelfth through eighteenth paragraphs of this summary, the product of the first average intensity and an average speed during the first period is equal to a product of the predetermined scanning speed and the second average intensity. In some implementations of such a method, the product of the third average intensity and an average speed during the third period is equal to the product of the predetermined scanning speed and the second average intensity.

In some implementations of a method such as described in any of the twelfth through nineteenth paragraphs of this summary, the first period is comprised by an acceleration period during which the stage is accelerated relative to the field of view of the camera from immobility to the predetermined scanning speed. In some such implementations, the set of non-uniform movement imaging acts comprises illuminating the field of view of the camera at the first average intensity during the first period by providing an illumination source illuminating the field of view of the camera current continuously during the acceleration period at levels which vary with speed of the stage during the acceleration period.

In some implementations of a method such as described in any of the twelfth through nineteenth paragraphs of this summary, the first period is comprised by an acceleration period during which the stage is accelerated relative to the field of view of the camera from immobility to the predetermined scanning speed. In some such implementations, the set of non-uniform movement imaging acts comprises illuminating the field of view of the camera at the first average intensity during the first period by providing an illumination source illuminating the field of view of the camera current in pulses at a rate which varies with the speed of the stage during the acceleration period.

Another implementation relates to a machine readable medium storing instructions for performing a method such as described in any of the twelfth through twenty first paragraphs of this summary.

Other features and aspects of the disclosed technology will become apparent from the following detailed description, taken in conjunction with the accompanying drawings, which illustrate, by way of example, the features in accordance with examples of the disclosed technology. The summary is not intended to limit the scope of any protection provided by this document or any related document, which scope is defined by the respective document's claims and equivalents.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The present disclosure, in accordance with one or more various examples, is described in detail with reference to the following figures. The figures are provided for purposes of illustration only and merely depict typical or example implementations.

FIG. 1 illustrates, in one example, a generalized block diagram of an example image scanning system with which systems and methods disclosed herein may be implemented.

FIG. 2 is block diagram illustrating an example two-channel, line-scanning modular optical imaging system that may be implemented in particular implementations.

FIG. 3 illustrates an example configuration of a patterned sample that may be imaged in accordance with implementations disclosed herein.

FIGS. 4A-4B depict motion profiles illustrating potential impacts of allowing imaging during periods of non-uniform motion.

FIG. 5 illustrates an example process in which illumination is modulated during periods of non-uniform motion.

FIG. 6 illustrates an example computing module that may be used to implement various features of implementations described in the present disclosure.

The figures are not exhaustive and do not limit the present disclosure to the precise form disclosed.

### DETAILED DESCRIPTION

As used herein to refer to a sample, the term “spot” or “feature” is intended to mean a point or area in a pattern that may be distinguished from other points or areas according to relative location. An individual spot may include one or more molecules of a particular type. For example, a spot may include a single target nucleic acid molecule having a particular sequence or a spot may include several nucleic acid molecules having the same sequence (and/or complementary sequence, thereof).

As used herein to refer to a spot or feature in connection with a direction, the term “pitch” is intended to mean the separation of the spot or feature from other spots or features in the direction. For example, if a sample container has an array of features which are separated from each other by 650 nm in the direction that the container would be moved during imaging, then the “pitch” of the features in that direction may be referred to as being 650 nm.

As used herein, the term “xy plane” is intended to mean a 2 dimensional area defined by straight line axes x and y in a Cartesian coordinate system. When used in reference to a detector and an object observed by the detector, the area may be further specified as being orthogonal to the direction of observation between the detector and object being detected. When used herein to refer to a line scanner, the term “y direction” refers to the direction of scanning.

As used herein, the term “z coordinate” is intended to mean information that specifies the location of a point, line or area along an axes that is orthogonal to an xy plane. In particular implementations, the z axis is orthogonal to an area of an object that is observed by a detector. For example, the direction of focus for an optical system may be specified along the z axis.

As used herein, the term “scan a line” is intended to mean detecting a 2-dimensional cross-section in an xy plane of an object, the cross-section being rectangular or oblong, and causing relative movement between the cross-section and the object. For example, in the case of fluorescence imaging an area of an object having rectangular or oblong shape may be specifically excited (at the exclusion of other areas) and/or emission from the area may be specifically acquired (at the exclusion of other areas) at a given time point in the scan.

Implementations disclosed herein are directed to illumination of objects to be imaged while in motion. Illumination may be provided for one or more brief intervals, and data corresponding to multiple illumination brief intervals may be combined to generate an image.

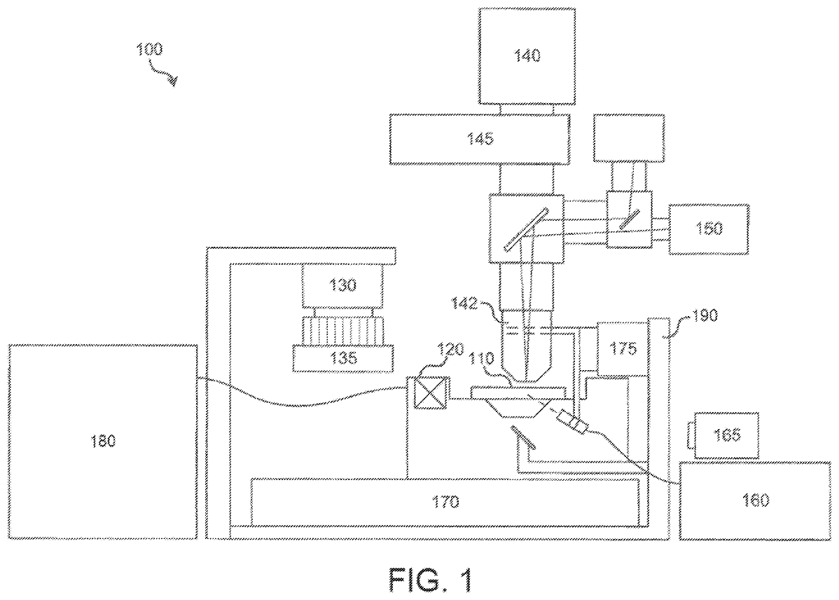

FIG. 1 is an example imaging system 100 in which the technology disclosed herein may be implemented. The example imaging system 100 may include a device for obtaining or producing an image of a sample. The example outlined in FIG. 1 shows an example imaging configuration of a backlight design implementation. It should be noted that although systems and methods may be described herein from time to time in the context of example imaging system 100, these are only examples with which implementations of the illumination and imaging techniques disclosed herein may be implemented.

As may be seen in the example of FIG. 1, subject samples are located on sample container 110 (e.g., a flow cell as described herein), which is positioned on a sample stage 170 mounted on a frame 190 under an objective lens 142. Light source 160 and associated optics direct a beam of light, such as laser light, to a chosen sample location on the sample container 110. The sample fluoresces and the resultant light is collected by the objective lens 142 and directed to an image sensor of camera system 140 to detect the florescence. Sample stage 170 is moved relative to objective lens 142 to position the next sample location on sample container 110 at the focal point of the objective lens 142. Movement of sample stage 170 relative to objective lens 142 may be achieved by moving the sample stage itself, the objective lens, some other component of the imaging system, or any combination of the foregoing. Further implementations may also include moving the entire imaging system over a stationary sample.

Fluid delivery module or device 180 directs the flow of reagents (e.g., fluorescently labeled nucleotides, buffers, enzymes, cleavage reagents, etc.) to (and through) sample container 110 and waste valve 120. Sample container 110 may include one or more substrates upon which the samples are provided. For example, in the case of a system to analyze a large number of different nucleic acid sequences, sample container 110 may include one or more substrates on which nucleic acids to be sequenced are bound, attached or associated. In various implementations, the substrate may include any inert substrate or matrix to which nucleic acids may be attached, such as for example glass surfaces, plastic surfaces, latex, dextran, polystyrene surfaces, polypropylene surfaces, polyacrylamide gels, gold surfaces, and silicon wafers. In some applications, the substrate is within a channel or other area at a plurality of locations formed in a matrix or array across the sample container 110.

In some implementations, the sample container 110 may include a biological sample that is imaged using one or more fluorescent dyes. For example, in a particular implementation the sample container 110 may be implemented as a patterned flow cell including a translucent cover plate, a substrate, and a liquid sandwiched therebetween, and a biological sample may be located at an inside surface of the translucent cover plate or an inside surface of the substrate. The flow cell may include a large number (e.g., thousands, millions, or billions) of wells or other types of spots (e.g., pads, divots) that are patterned into a defined array (e.g., a hexagonal array, rectangular array, etc.) into the substrate. Each spot may form a cluster (e.g., a monoclonal cluster) of a biological sample such as DNA, RNA, or another genomic material which may be sequenced, for example, using sequencing by synthesis. The flow cell may be further divided into a number of spaced apart lanes (e.g., eight lanes), each lane including a hexagonal array of clusters. Example flow cells that may be used in implementations disclosed herein are described in U.S. Pat. No. 8,778,848.

The system also comprises temperature station actuator 130 and heater/cooler 135 that may optionally regulate the temperature of conditions of the fluids within the sample container 110. Camera system 140 may be included to monitor and track the sequencing of sample container 110. Camera system 140 may be implemented, for example, as a charge-coupled device (CCD) camera (e.g., a time delay integration (TDI) CCD camera), which may interact with various filters within filter switching assembly 145, objective lens 142, and focusing laser/focusing laser assembly 150. Camera system 140 is not limited to a CCD camera and other cameras and image sensor technologies may be used. In particular implementations, the camera sensor may have a pixel size between about 5 and about 15 μm, though other pixel sizes, such as 2.4 μm may also be used in some cases.

Output data from the sensors of camera system 140 may be communicated to a real time analysis module (not shown) that may be implemented as a software application that analyzes the image data (e.g., image quality scoring), reports or displays the characteristics of the laser beam (e.g., focus, shape, intensity, power, brightness, position) to a graphical user interface (GUI), and, as further described below, dynamically corrects distortion in the image data.

Light source 160 (e.g., an excitation laser within an assembly optionally comprising multiple lasers) or other light source may be included to illuminate fluorescent sequencing reactions within the samples via illumination through a fiber optic interface (which may optionally comprise one or more re-imaging lenses, a fiber optic mounting, etc.). Low watt lamp 165 and focusing laser 150 also presented in the example shown. In some implementations focusing laser 150 may be turned off during imaging. In other implementations, an alternative focus configuration may include a second focusing camera (not shown), which may be a quadrant detector, a Position Sensitive Detector (PSD), or similar detector to measure the location of the scattered beam reflected from the surface concurrent with data collection.

Although illustrated as a backlit device, other examples may include a light from a laser or other light source that is directed through the objective lens 142 onto the samples on sample container 110. Sample container 110 may be ultimately mounted on a sample stage 170 to provide movement and alignment of the sample container 110 relative to the objective lens 142. The sample stage may have one or more actuators to allow it to move in any of three dimensions. For example, in terms of the Cartesian coordinate system, actuators may be provided to allow the stage to move in the X, Y and Z directions relative to the objective lens. This may allow one or more sample locations on sample container 110 to be positioned in optical alignment with objective lens 142.

A focus (z-axis) component 175 is shown in this example as being included to control positioning of the optical components relative to the sample container 110 in the focus direction (typically referred to as the z axis, or z direction). Focus component 175 may include one or more actuators physically coupled to the optical stage or the sample stage, or both, to move sample container 110 on sample stage 170 relative to the optical components (e.g., the objective lens 142) to provide proper focusing for the imaging operation. For example, the actuator may be physically coupled to the respective stage such as, for example, by mechanical, magnetic, fluidic or other attachment or contact directly or indirectly to or with the stage. The one or more actuators may move the stage in the z-direction while maintaining the sample stage in the same plane (e.g., maintaining a level or horizontal attitude, perpendicular to the optical axis). The one or more actuators may also tilt the stage. This may be done, for example, so that sample container 110 may be leveled dynamically to account for any slope in its surfaces.

Focusing of the system generally refers to aligning the focal plane of the objective lens with the sample to be imaged at the chosen sample location. However, focusing may also refer to adjustments to the system to obtain a desired characteristic for a representation of the sample such as, for example, a desired level of sharpness or contrast for an image of a test sample. Because the usable depth of field of the focal plane of the objective lens may be small (sometimes on the order of 1 μm or less), focus component 175 closely follows the surface being imaged. Because the sample container is not perfectly flat as fixtured in the instrument, focus component 175 may be set up to follow this profile while moving along in the scanning direction (herein referred to as the y-axis).

The light emanating from a test sample at a sample location being imaged may be directed to one or more detectors of camera system 140. An aperture may be included and positioned to allow only light emanating from the focus area to pass to the detector. The aperture may be included to improve image quality by filtering out components of the light that emanate from areas that are outside of the focus area. Emission filters may be included in filter switching assembly 145, which may be selected to record a determined emission wavelength and to cut out any stray laser light.

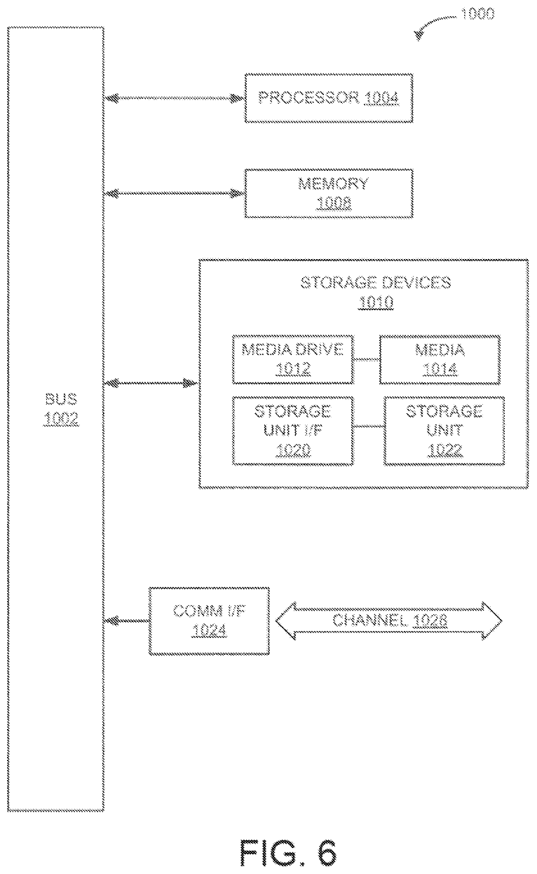

Although not illustrated, a controller, which may be implemented as a computing module such as discussed infra in the context of FIG. 6, may be provided to control the operation of the scanning system. The controller may be implemented to control aspects of system operation such as, for example, focusing, stage movement, and imaging operations. In various implementations, the controller may be implemented using hardware, algorithms (e.g., machine executable instructions), or a combination of the foregoing. For example, in some implementations the controller may include one or more CPUs or processors with associated memory. As another example, the controller may comprise hardware or other circuitry to control the operation, such as a computer processor and a non-transitory computer readable medium with machine-readable instructions stored thereon. For example, this circuitry may include one or more of the following: field programmable gate array (FPGA), application specific integrated circuit (ASIC), programmable logic device (PLD), complex programmable logic device (CPLD), a programmable logic array (PLA), programmable array logic (PAL) or other similar processing device or circuitry. As yet another example, the controller may comprise a combination of this circuitry with one or more processors.

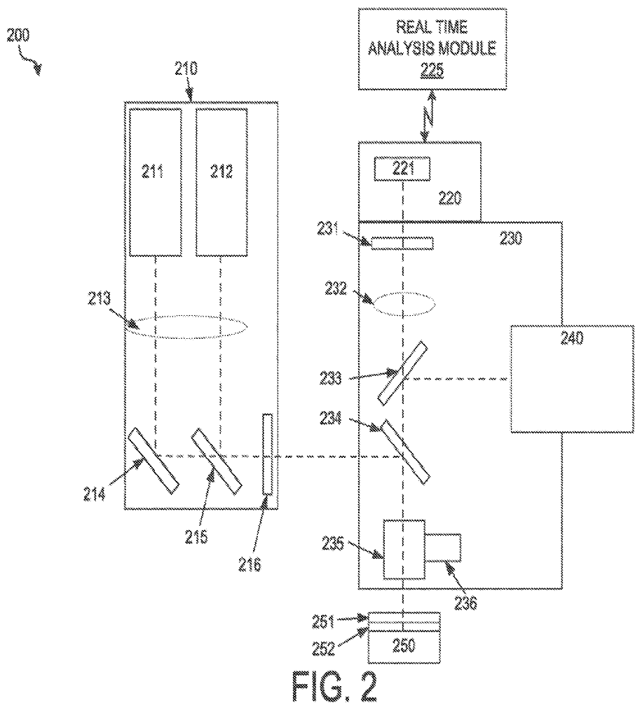

Other imaging systems may also be used when implementing the disclosed technology. For example, FIG. 2 is a block diagram illustrating an example two-channel, line-scanning modular optical imaging system 200 in which aspects of the disclosed technology may be implemented. In some implementations, system 200 may be used for the sequencing of nucleic acids. Applicable techniques include those where nucleic acids are attached at fixed locations in an array (e.g., the wells of a flow cell) and the array is imaged repeatedly while in motion relative to the field of view of a camera in the imaging system 200. In such implementations, system 200 may obtain images in two different color channels, which may be used to distinguish a particular nucleotide base type from another. More particularly, system 200 may implement a process referred to as “base calling,” which generally refers to a process of a determining a base call (e.g., adenine (A), cytosine (C), guanine (G), or thymine (T)) for a given spot location of an image at an imaging cycle. During two-channel base calling, image data extracted from two images may be used to determine the presence of one of four base types by encoding base identity as a combination of the intensities of the two images. For a given spot or location in each of the two images, base identity may be determined based on whether the combination of signal identities is [on, on], [on, off], [off, on], or [off, off].

Referring again to imaging system 200, the system includes a line generation module (LGM) 210 with two light sources, 211 and 212, disposed therein. Light sources 211 and 212 may be coherent light sources such as laser diodes which output laser beams. Light source 211 may emit light in a first wavelength (e.g., a red color wavelength), and light source 212 may emit light in a second wavelength (e.g., a green color wavelength). The light beams output from laser sources 211 and 212 may be directed through a beam shaping lens or lenses 213. In some implementations, a single light shaping lens may be used to shape the light beams output from both light sources. In other implementations, a separate beam shaping lens may be used for each light beam. In some examples, the beam shaping lens is a Powell lens, such that the light beams are shaped into line patterns. The beam shaping lenses of LGM 210 or other optical components imaging system may shape the light emitted by light sources 211 and 212 into a line patterns (e.g., by using one or more Powel lenses, or other beam shaping lenses, diffractive or scattering components).

LGM 210 may further include mirror 214 and semi-reflective mirror 215 to direct the light beams through a single interface port to an emission optics module (EOM) 230. The light beams may pass through a shutter element 216. EOM 230 may include objective 235 and a z-stage 236 which moves objective lens 235 longitudinally closer to or further away from a target 250. For example, target 250 may include a liquid layer 252 and a translucent cover plate 251, and a biological sample may be located at an inside surface of the translucent cover plate as well an inside surface of the substrate layer located below the liquid layer. The z-stage 236 may then move the objective as to focus the light beams onto either inside surface of the flow cell (e.g., focused on the biological sample). Similarly, in some implementations, the target 250 may be mounted on, or include a stage movable in the xy plane relative to the objective lens 235. The biological sample may be DNA, RNA, proteins, or other biological materials responsive to optical sequencing as known in the art.

EOM 230 may include semi-reflective mirror 233 to reflect a focus tracking light beam emitted from a focus tracking module (FTM) 240 onto target 250, and then to reflect light returned from target 250 back into FTM 240. FTM 240 may include a focus tracking optical sensor to detect characteristics of the returned focus tracking light beam and generate a feedback signal to optimize focus of objective 235 on target 250.

EOM 230 may also include semi-reflective mirror 234 to direct light through objective lens 235, while allowing light returned from target 250 to pass through. In some implementations, EOM 230 may include a tube lens 232. Light transmitted through tube lens 232 may pass through filter element 231 and into camera module (CAM) 220. CAM 220 may include one or more optical sensors 221 to detect light emitted from the biological sample in response to the incident light beams (e.g., fluorescence in response to red and green light received from light sources 211 and 212).

Output data from the sensors of CAM 220 may be communicated to a real time analysis module 225. Real time analysis module, in various implementations, executes computer readable instructions for analyzing the image data (e.g., image quality scoring, base calling, etc.), reporting or displaying the characteristics of the beam (e.g., focus, shape, intensity, power, brightness, position) to a graphical user interface (GUI), etc. These operations may be performed in real-time during imaging cycles to minimize downstream analysis time and provide real time feedback and troubleshooting during an imaging run. In implementations, real time analysis module may be a computing device (e.g., computing device 1000) that is communicatively coupled to and controls imaging system 200. In implementations further described below, real time analysis module 225 may additionally execute computer readable instructions for controlling illumination of the target 250 and optionally for integrating data gathered during multiple exposures of the optical sensor(s) 221 into an image.

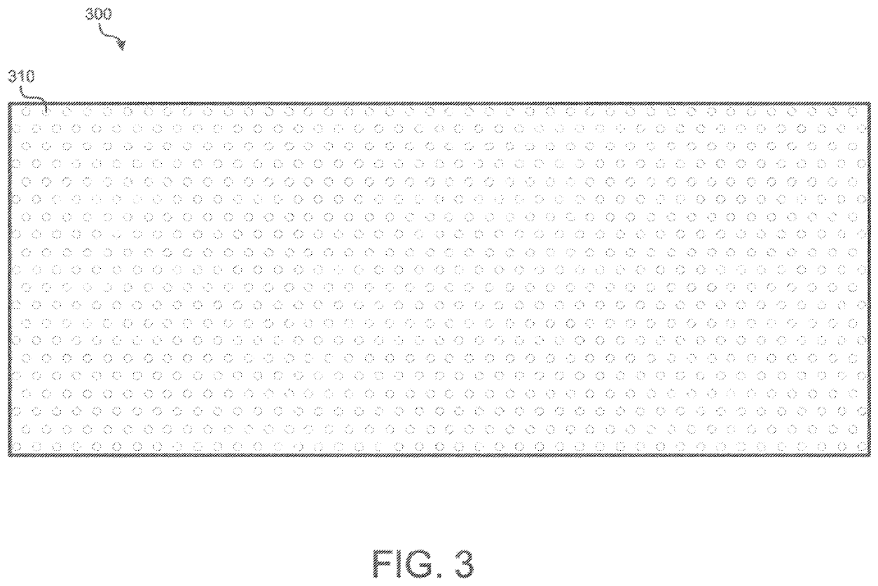

FIG. 3 illustrates an example configuration of a sample container 300 that may be imaged in accordance with implementations disclosed herein. In this example, sample container 300 is patterned with a hexagonal array of ordered spots 310 that may be simultaneously imaged during an imaging run. Although a hexagonal array is illustrated in this example, in other implementations the sample container may be patterned using a rectilinear array, a circular array, an octagonal array, or some other array pattern. For ease of illustration, sample container 300 is illustrated as having tens to hundreds of spots 310. However, as may be appreciated by one having skill in the art, sample container 300 may have thousands, millions, or billions of spots 310 that are imaged. Moreover, in some instances, sample container 300 may be a multi-plane sample comprising multiple planes (perpendicular to focusing direction) of spots 310 that are sampled during an imaging run.

In a particular implementation, sample container 300 may be a flow cell patterned with millions or billions of wells that are divided into lanes. In this particular implementation, each well of the flow cell may contain biological material that is sequenced using sequencing by synthesis.

As discussed above, illumination and imaging of objects in motion relative to the field of view of an imaging device has been accomplished through high precision motion stages, time delay integration (TDI) cameras, and diode pumped solid state lasers. To achieve consistent data collection, imaging has been limited to periods during which the motion of the objects to be imaged relative to the devices used to image them (e.g., TDI cameras) is uniform. However, implementations of the disclosed technology may achieve the same goal while allowing imaging to extend to periods when objects to be imaged are accelerating or decelerating relative to the devices used for imaging. This may include imaging during periods of acceleration and deceleration at the inception and conclusion of imaging for a sample, and may also include other periods of non-uniform motion during sample imaging. For example, in some cases after a swath is scanned, there will be a period of deceleration while an imaging system such as illustrated in FIGS. 1-2 decelerates, changes to a next swath, and then reaccelerates to a uniform scanning speed for imaging of that next swath. In some cases, implementations of the disclosed technology may allow for imaging during these swath changeover periods, either in addition to, or as an alternative to, allowing for imaging at the inception and conclusion of scanning a sample.

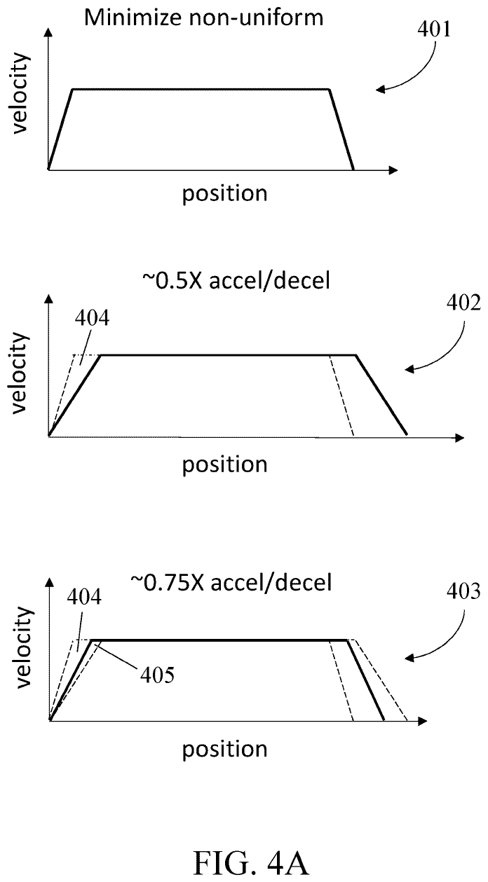

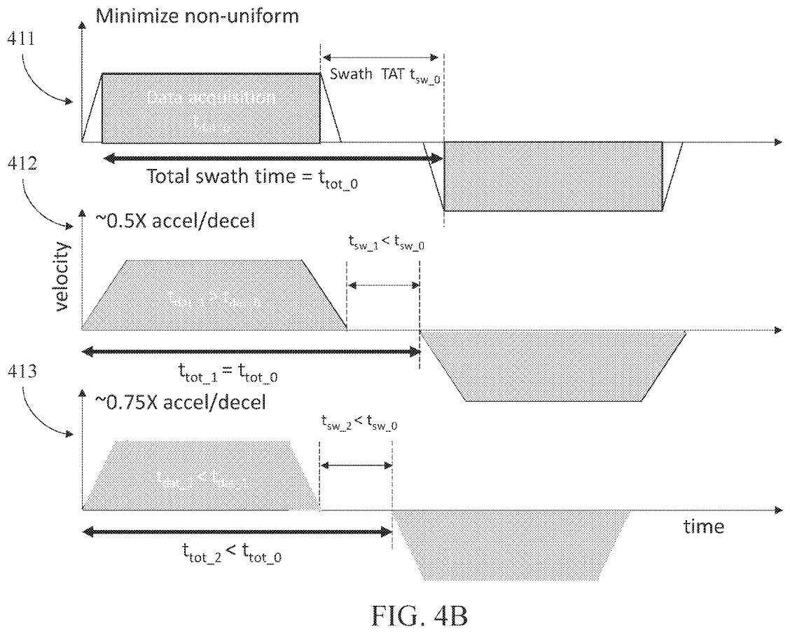

To illustrate potential impacts of allowing imaging during periods of non-uniform motion, consider FIGS. 4A-4B. FIG. 4A provides three motion profiles depicting the velocity of a sample on a stage relative to an imaging device as a function of the sample's position relative to the imaging device. First, FIG. 4A depicts a first motion profile 401 for a scenario in which non-uniform motion is minimized. This may be done, for example, in an imaging system designed to accelerate and decelerate the sample as quickly as possible because imaging would only take place when the sample was moving at a predefined uniform scanning velocity. FIG. 4A also depicts second and third motion profiles 402 403 corresponding to scenarios in which acceleration and deceleration are, respectively, 50% and 75% of the acceleration and deceleration for the first motion profile 401. In those motion profiles 402 403, the area 404 between the solid motion profile line and exterior dotted lines represents a decrease in the amount of space during which the sample could be imaged while moving at the uniform scanning velocity for the lower acceleration/deceleration motion profiles 402 403 relative to the first motion profile 401. Similarly, the area 405 between the solid motion profile line and interior dotted lines in the third motion profile 403 represents the increase in the amount of space during which the sample could be imaged while moving at the uniform scanning velocity for third motion profile 403 relative to the second motion profile 402, thereby demonstrating the impact of acceleration/deceleration on potential uniform motion scanning time in terms of position.

Like FIG. 4A, FIG. 4B provides three motion profiles. However, the profiles of FIG. 4B illustrate velocity relative to time, as opposed to velocity relative to position, and use this velocity relative to time depiction to show the impact of allowing imaging during periods of non-uniform motion on the total time for a swath, with the total time for the swath including the time the swath is being imaged as well as the turnaround time between when imaging for one swath ends and imaging for the next swath begins. Like the first motion profile 401 in FIG. 4A, the first motion profile 411 in FIG. 4B shows a motion profile for a case where an imaging system is designed to accelerate and decelerate as rapidly as possible, with FIG. 4B explicitly depicting data acquisition time (t_{dat_0}) when such a system only captures images when the sample is at a uniform scanning velocity. The second and third motion profiles 412 413 of FIG. 4B depict velocity over time of samples which are accelerated and decelerated at, respectively, 50% and 75% of the acceleration and deceleration of the first motion profile 411 of FIG. 4B. As shown in FIG. 4B, in cases where images are captured during periods of acceleration and deceleration, the total time for a swath which is accelerated and decelerated at less than the maximum depicted rate may be equal to (in the illustrated case of 50% acceleration and deceleration) or less than (in the illustrated case of 75% acceleration and deceleration) the total time for a swath which is accelerated and decelerated at the maximum rate indicated.

A further illustration of the potential impact of changing acceleration and deceleration while allowing images to be captured when a sample is not at its uniform scanning velocity is provided below in table 1. That table illustrates exemplary values for acceleration, scanning velocity, turnaround time and other parameters which could impact image acquisition in systems following the motion profiles of FIGS. 4A and 4B.

TABLE 1

| | | Minimize | 0.5X | 0.75X |
|---|---|---|---|---|
| | Units | non-uniform | accel/decel | accel/decel |
| Scanning | mm/s | 48.0 | 48.0 | 48.0 |
| Velocity | | | | |
| Accel/Decel | mm/s² | 360.0 | 180.0 | 270.0 |
| Constant Vel | mm | 120 | 114 | 118 |
| Length | | | | |
| Accel length | mm | 3.2 | 6.4 | 4.3 |
| Swath scanning | s | 2.5 | 2.4 | 2.5 |
| velocity time | | | | |
| Straight | s | 0.1 | 0.3 | 0.2 |
| accel/decel time | | | | |
| S-curve | s | 0.3 | 0.5 | 0.4 |
| accel/decel time | | | | |
| Swath | s | 2.8 | 2.9 | 2.8 |
| acquisition time | | | | |
| (straight | | | | |
| accel/decel) | | | | |
| Swath | s | 3.0 | 3.4 | 3.2 |
| acquisition time | | | | |
| (s-curve | | | | |
| accel/decel) | | | | |
| Turnaround time | s | 0.8 | 0.4 | 0.5 |
| Total Swath time | s | 3.5 | 3.3 | 3.3 |
| (straight | | | | |
| accel/decel) | | | | |
| Total swath time | s | 3.8 | 3.8 | 3.7 |

While FIGS. 4A and 4B and table 1 illustrate how imaging during non-uniform motion may allow for performance which is equal to, or better than, that achievable by a system which has higher acceleration but only captures images while a sample is at constant velocity, it should be understood that those figures and table 1 are intended to be illustrative only, and are not intended to represent precise motion profiles which would necessarily be present in systems implemented based on this disclosure. For example, in a system based on this disclosure, rather than having the flat sides illustrated in FIGS. 4A and 4B, periods of acceleration and deceleration in a motion profile would most likely have an s-curve shape, reflecting that acceleration would change over time rather than being constant. Similarly, while potential relative turnaround times for swaths were illustrated, turnaround times may vary significantly from system to system, and could be greater (e.g., in a case where a system lower maximum acceleration and deceleration was made with less expensive components, and those less expensive components also increased the time required to switch from swath to swath) or less (e.g., in a system where a sample switched from one swath to another by following a curve rather than stopping, switching and starting again, in which case imaging may run continuously when switching from one swath to another) than the times illustrated in the figures and table 1. Accordingly, the profiles of, and discussion accompanying, FIGS. 4A, 4B and table 1 should be understood as being illustrative only, and should not be treated as implying limitations on the scope of protection provided by this document or any related document.

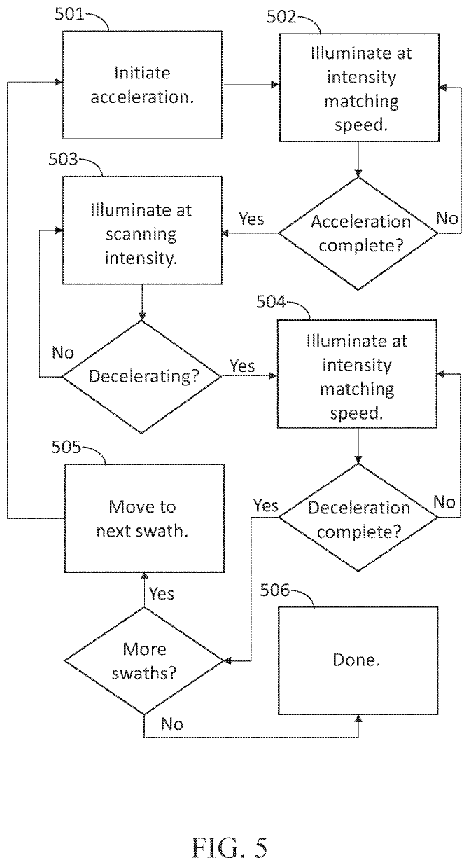

Turning now to FIG. 5, that figure illustrates a method which could be used to support imaging during periods of non-uniform motion, such as described above in the context of the second and third motion profiles 402 403 412 413 of FIGS. 4A and 4B. The method of FIG. 5 begins with initiating acceleration of a sample relative to an imaging device in block 501. As shown in block 502, while the sample is accelerating, it could be illuminated at an intensity matching its then current speed. To support this, in some embodiments a motion profile for the sample may be provided to the controller of a laser diode, light emitting diode or other illumination source. The illumination controller may then provide current at a level which is proportionately lower than current used when the system is at maximum sample velocity based on the longer distance a sample will be within an imaging device's (e.g., a TDI camera's) field of view while it is accelerating. In this way, a system implemented to perform a method such as shown in FIG. 5 may modulate illumination while the sample is undergoing non-uniform motion such that the product of illumination and average speed is constant for all imaging periods. For example, the relationship between the illumination provided during a period of time while the sample was being accelerated, and the illumination provided when the sample was moving at its maximum speed (e.g., scanning speed) may be expressed by equation 1, below:

$${I}_{01} * ( {V}_{0} + {V}_{1} ) / 2 = {I}_{s} * {V}_{s} \qquad Equation 1$$

In the above equation, I₀₁ refers to the illumination to be provided from time 0 to time 1 (e.g., from the beginning to the end of the period of acceleration, from the beginning of acceleration to the end of the first 0.1 second time increment of acceleration, etc.). Iₛ refers to the illumination provided to the sample while it was being scanned at the system's maximum speed (e.g., illumination provided when the sample is moving at 48.0 mm/s in a system having the scanning velocity set forth in table 1). V₀ and V₁ refer to the velocity of the sample at, respectively, time 0 and time 1. Vₛ refers to the speed at which the sample would be moving when it was being scanned at the system's maximum speed (e.g., 48.0 mm/s, in a system having the scanning velocity set forth in table 1). Accordingly, illuminating the sample at an intensity matching its velocity, as shown in block 502, may be achieved by illuminating the sample with intensity I₀₁ satisfying an equation such as equation 1.

In the method of FIG. 5, once acceleration was complete and the sample reached its uniform scanning velocity, it could continue to be illuminated at the system's scanning intensity (e.g., 0.5 watts) as shown in block 503. This could continue until the sample begins its deceleration (e.g., when the end of a swath is being reached and the system is decelerating to either move to the next swath or for another sample to be loaded). While the sample was decelerating, in block 504 it could be illuminated at an intensity matching its then current speed, such as through the use of current modification as described above. When the deceleration was complete, if there were more swaths, then the system could move to the next swath in block 505. For example, in a case where a sample container 300 such as shown in FIG. 3 was moved horizontally relative to an imaging device during scanning, moving to the next swath in block 505 may be achieved by moving vertically such that the next horizontal set of spots was then within the field of view of the imaging device. During this period, while the sample was stationary in the direction it would move while being scanned, illumination and imaging of the sample may be suspended. After a system performing a method such as shown in FIG. 5 had moved to the next swath in block 505, it could then return to block 501, accelerating that next swath to the scanning velocity and imaging it both at the scanning velocity and during the acceleration period as described above. Alternatively, if there were no further swaths, then the process of FIG. 5 could terminate in block 506 (e.g., for a next sample to be loaded so that it could be imaged as described).

It should be understood that the approaches described above, and examples of how those approaches may be applied, are intended to be illustrative only, and that other approaches, and variations on the described approaches, are possible and may be applied in some implementations. To illustrate, consider approaches used to modulate the intensity of illumination provided to a sample during periods of non-uniform movement (e.g., acceleration and deceleration). While it is possible that some implementations may control the intensity of illumination through increasing or reducing the current provided to an illumination source, another approach which may be used in some cases is to illuminate a sample with high frequency pulses, setting an illumination source's duty cycle such that the total illumination provided to a feature while it is within the field of view of an imaging device was the same as would be provided when the sample was being scanned at the system's scanning velocity. Similarly, while some implementations may set the intensity of illumination by providing motion a motion profile to a controller of an illumination source, another approach would be to synchronize illumination with pulses of an encoder used to measure the position of a sample (e.g., through pulse width modulation). For instance, some such versions may provide pulse width modulation (PWM). However, in versions that use PWM, the pulses of the PWM need not necessarily synchronize with pulses of the encoder.

It is also possible that, in some implementations, imaging during periods of non-uniform motion may be supported without requiring modification of illumination such as described above in the context of FIG. 5. For example, in some cases, a sample may be illuminated at a constant intensity (e.g., 0.5 watts) throughout imaging and a normalization process may be applied to the captured images to account for the greater illumination dose which would be provided when imaging features during periods of relatively lower velocity (e.g., while the sample was being accelerated to its scanning velocity). For example, in some systems, signals for features (e.g., light emitted by a sample in a well in response to incident light) in an exposure may be used to derive analysis signals by multiplying a signal in an exposure by the instantaneous velocity of the feature (e.g., as determined using encoder measurements, or by matching the time an exposure is captured with a motion profile) when the exposure was captured. Using this approach, the signal for features imaged during periods of acceleration or deceleration would be multiplied by a lower normalization factor (e.g., a lower velocity) than the signal for features imaged when the sample was moving at its scanning velocity. This would providing analysis signals having a uniform response profile (i.e., the same signal could be treated as having the same meaning across analysis images) that could be used for purposes such as base calling.

Variations are also possible in potential uses of imaging during periods of non-uniform movement. For example, in some cases periods of non-uniform movement may be used to gather information about a sample which would be used for purposes such as base calling during nucleotide sequencing. However, in other cases, images captured during periods of non-uniform movement may be used for purposes such as focusing an imaging device. Combined approaches, such as using an initial acceleration period for focusing, and then using subsequent periods of acceleration and deceleration for capturing images of a sample for use in base calling, as well as other types of variation, such as continuing to illuminate and capture images of a sample while moving to a new swath in block 505, are also possible, will be immediately apparent to, and could be implemented without undue experimentation by, those of ordinary skill in light of this disclosure. Accordingly, the above description of potential variations, like the descriptions of FIGS. 4A-B and 5, should be understood as being illustrative only, and should not be treated as limiting.

Turning now to FIG. 6, that figure illustrates an example computing component that may be used to implement various features of the system and methods disclosed herein, such as the aforementioned features and functionality of one or more aspects of methods 400 and 450. For example, computing component may be implemented as a real-time analysis module 225.

As used herein, the term module may describe a given unit of functionality that may be performed in accordance with one or more implementations of the present application. As used herein, a module may be implemented utilizing any form of hardware, software, or a combination thereof. For example, one or more processors, controllers, ASICs, PLAS, PALs, CPLDs, FPGAS, logical components, software routines or other mechanisms may be implemented to make up a module. In implementation, the various modules described herein may be implemented as discrete modules or the functions and features described may be shared in part or in total among one or more modules. In other words, as may be apparent to one of ordinary skill in the art after reading this description, the various features and functionality described herein may be implemented in any given application and may be implemented in one or more separate or shared modules in various combinations and permutations. Even though various features or elements of functionality may be individually described or claimed as separate modules, one of ordinary skill in the art will understand that these features and functionality may be shared among one or more common software and hardware elements, and such description shall not require or imply that separate hardware or software components are used to implement such features or functionality.

Where components or modules of the application are implemented in whole or in part using software, in one implementation, these software elements may be implemented to operate with a computing or processing module capable of carrying out the functionality described with respect thereto. One such example computing module is shown in FIG. 6. Various implementations are described in terms of this example-computing module 1000. After reading this description, it will become apparent to a person skilled in the relevant art how to implement the application using other computing modules or architectures.

Referring now to FIG. 6, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1000 may also represent computing capabilities embedded within or otherwise available to a given device. For example, a computing module may be found in other electronic devices such as, for example, digital cameras, navigation systems, cellular telephones, portable computing devices, modems, routers, WAPs, terminals and other electronic devices that may include some form of processing capability.

Computing module 1000 may include, for example, one or more processors, controllers, control modules, or other processing devices, such as a processor 1004. Processor 1004 may be implemented using a general-purpose or special-purpose processing engine such as, for example, a microprocessor, controller, or other control logic. In the illustrated example, processor 1004 is connected to a bus 1002, although any communication medium may be used to facilitate interaction with other components of computing module 1000 or to communicate externally.

Computing module 1000 may also include one or more memory modules, referred to herein as main memory 1008. For example, preferably random access memory (RAM) or other dynamic memory, may be used for storing information and instructions to be executed by processor 1004. Main memory 1008 may also be used for storing temporary variables or other intermediate information during execution of instructions to be executed by processor 1004. Computing module 1000 may likewise include a read only memory (“ROM”) or other static storage device coupled to bus 1002 for storing static information and instructions for processor 1004.

The computing module 1000 may also include one or more various forms of information storage mechanism 1010, which may include, for example, a media drive 1012 and a storage unit interface 1020. The media drive 1012 may include a drive or other mechanism to support fixed or removable storage media 1014. For example, a hard disk drive, a solid state drive, a magnetic tape drive, an optical disk drive, a CD or DVD drive (R or RW), or other removable or fixed media drive may be provided. Accordingly, storage media 1014 may include, for example, a hard disk, a solid state drive, magnetic tape, cartridge, optical disk, a CD, DVD, or Blu-ray, or other fixed or removable medium that is read by, written to or accessed by media drive 1012. As these examples illustrate, the storage media 1014 may include a computer usable storage medium having stored therein computer software or data.

In alternative implementations, information storage mechanism 1010 may include other similar instrumentalities for allowing computer programs or other instructions or data to be loaded into computing module 1000. Such instrumentalities may include, for example, a fixed or removable storage unit 1022 and an interface 1020. Examples of such storage units 1022 and interfaces 1020 may include a program cartridge and cartridge interface, a removable memory (for example, a flash memory or other removable memory module) and memory slot, a PCMCIA slot and card, and other fixed or removable storage units 1022 and interfaces 1020 that allow software and data to be transferred from the storage unit 1022 to computing module 1000.

Computing module 1000 may also include a communications interface 1024. Communications interface 1024 may be used to allow software and data to be transferred between computing module 1000 and external devices. Examples of communications interface 1024 may include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 may typically be carried on signals, which may be electronic, electromagnetic (which includes optical) or other signals capable of being exchanged by a given communications interface 1024. These signals may be provided to communications interface 1024 via a channel 1028. This channel 1028 may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer readable medium”, “computer usable medium” and “computer program medium” are used to generally refer to non-transitory media, volatile or non-volatile, such as, for example, memory 1008, storage unit 1022, and media 1014. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 1000 to perform features or functions of the present application as discussed herein.

Although described above in terms of various implementations and implementations, it should be understood that the various features, aspects and functionality described in one or more of the individual implementations are not limited in their applicability to the particular implementation with which they are described, but instead may be applied, alone or in various combinations, to one or more of the other implementations of the application, whether or not such implementations are described and whether or not such features are presented as being a part of a described implementation. Thus, the breadth and scope of protection provided by this document or any related document should not be limited by any of the above-described implementations.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

The terms “substantially” and “about” used throughout this disclosure, including the claims, are used to describe and account for small fluctuations, such as due to variations in processing. For example, they may refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

To the extent applicable, the terms “first,” “second,” “third,” etc. herein are merely employed to show the respective objects described by these terms as separate entities and are not meant to connote a sense of chronological order, unless stated explicitly otherwise herein.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide instances of the item in discussion, not an exhaustive or limiting list thereof; the terms “a” or “an” should be read as meaning “at least one,” “one or more” or the like; and adjectives such as “preexisting,” “traditional,” “normal,” “standard,” “known” and terms of similar meaning should not be construed as limiting the item described to a given time period or to an item available as of a given time, but instead should be read to encompass preexisting, traditional, normal, or standard technologies that may be available or known now or at any time in the future. Likewise, where this document refers to technologies that may be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various implementations set forth herein are described in terms of block diagrams, flow charts and other illustrations. As will become apparent to one of ordinary skill in the art after reading this document, the illustrated implementations and their various alternatives may be implemented without confinement to the illustrated examples. For example, block diagrams and their accompanying description should not be construed as mandating a particular architecture or configuration.

While various implementations of the present disclosure have been described above, it should be understood that they have been presented by way of example only, and not of limitation. Likewise, the various diagrams may depict an example architectural or other configuration for the disclosure, which is done to aid in understanding the features and functionality that may be included in the disclosure. The disclosure is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present disclosure. Also, a multitude of different constituent module names other than those depicted herein may be applied to the various partitions. Additionally, with regard to flow diagrams, operational descriptions and method claims, the order in which the acts are presented herein shall not mandate that various implementations be implemented to perform the recited functionality in the same order unless the context dictates otherwise.

1. A machine comprising:
a stage;
a camera to capture images;
an actuation system to move the stage relative to a field of view of the camera which overlaps the stage;
an illumination source to illuminate the field of view of the camera; and
a controller to generate a set of analysis signals for features of a sample container on the stage, wherein each of the analysis signals has a uniform response profile, by performing acts comprising a set of non-uniform movement imaging acts comprising:
during a first period, accelerating the stage relative to the field of view of the camera from a first speed to a second speed, and illuminating the field of view of the camera at a first average intensity;
during a second period which follows the first period, moving the stage relative to the field of view of the camera at a predetermined, substantially constant scanning speed, and illuminating the field of view of the camera at a second intensity, the second intensity being substantially constant, wherein the predetermined scanning speed is greater than or equal to the second speed;
during a third period which follows the second period, decelerating the stage relative to the field of view of the camera from a third speed to a fourth speed, and illuminating the field of view of the camera at a third average intensity, wherein the third speed is less than or equal to the predetermined scanning speed; and
capturing exposures of features of the sample container on the stage during the first period, the second period, and the third period.

2. The machine of claim 1, wherein the controller is to illuminate the field of view of the camera at the first average intensity during the first period, the second intensity during the second period, and the third average intensity during the third period by performing acts comprising providing a motion profile for the stage to an illumination controller, wherein the illumination controller is to provide the uniform response profile for each of the analysis signals by continuously modulating intensity of the illumination source based on speed of the stage when the stage is accelerating relative to the field of view of the camera and when the stage is decelerating relative to the field of view of the camera.

3. The machine of claim 1, wherein the machine comprises an illumination controller to control the illumination source, and an encoder to provide measurements of a position of the stage, and wherein the controller is to illuminate the field of view of the camera at the first average intensity during the first period by performing acts comprising synchronizing measurements of the position of the stage from the encoder with the illumination controller.

4. The machine of claim 1, wherein:
The first average intensity, the second intensity and the third average intensity are all equal; and
the controller is to generate the set of analysis signals by performing acts comprising, for each exposure of features of the sample container on the stage, normalizing data from that exposure based on a speed of the stage when that exposure is captured.

5. The machine of claim 1, wherein:
the actuation system is a motor;
the camera is a time delay integration (TDI) line scan camera; and
the illumination source is selected from a group consisting of:
a diode laser; and
a light emitting diode.

6. The machine of claim 1, wherein:
the first period comprises an acceleration period during which the controller is to accelerate the stage relative to the field of view of the camera from immobility to the predetermined scanning speed;
the third period comprises a deceleration period during which the controller is to decelerate the stage relative to the field of view of the camera from the predetermined scanning speed to immobility;
the controller is to perform the set of non-uniform movement imaging acts a plurality of times, with each performance of the set of non-uniform movement imaging acts corresponding to a swath of features of the sample container;
during each performance of the set of non-uniform movement imaging acts, the controller is to move the stage relative to the field of view of the camera in a scanning direction; and
the controller is to, between any two consecutive performances of the set of non-uniform movement imaging acts, move from a swath corresponding to a first performance from the two consecutive performances to a swath corresponding to a second performance from the two consecutive performances by moving the stage in a direction oblique to the scanning direction.

7. The machine of claim 1, wherein the controller is to focus the camera, during the second period, based on exposures of features of the sample container on the stage captured at the end of the first period.

8. The machine of claim 1, wherein:
a product of the first average intensity and an average speed during the first period is equal to a product of the predetermined scanning speed and the second intensity; and
a product of the third average intensity and an average speed during the third period is equal to the product of the predetermined scanning speed and the second intensity.

9. The machine of claim 1, wherein:
the first period is comprised by an acceleration period during which the controller is to accelerate the stage relative to the field of view of the camera from immobility to the predetermined scanning speed; and
the set of non-uniform movement imaging acts comprises illuminating the field of view of the camera at the first average intensity during the first period by providing the illumination source current continuously during the acceleration period at levels which vary with speed of the stage during the acceleration period.

10. The machine of claim 1, wherein:
the first period is comprised by an acceleration period during which the controller is to accelerate the stage relative to the field of view of the camera from immobility to the predetermined scanning speed; and
the set of non-uniform movement imaging acts comprises illuminating the field of view of the camera at the first average intensity during the first period by providing the illumination source current in pulses at a rate which varies with speed of the stage during the acceleration period.

11. A method comprising:
generating a set of analysis signals for features of a sample container, wherein each of the analysis signals has a uniform response profile, by performing acts comprising performing a set of non-uniform movement imaging acts comprising:
during a first period, accelerating a stage relative to a field of view of a camera from a first speed to a second speed, and illuminating the field of view of the camera at a first average intensity;
during a second period which follows the first period, moving the stage relative to the field of view of the camera at a predetermined scanning speed, and illuminating the field of view of the camera at a second average intensity, the predetermined scanning speed is greater than or equal to the second speed;
during a third period which follows the second period, decelerating the stage relative to the field of view of the camera from a third speed to a fourth speed, and illuminating the field of view of the camera at a third average intensity, wherein the third speed is less than or equal to the predetermined scanning speed; and
capturing exposures of features of the sample container on the stage during the first period, the second period, and the third period.

12. The method of claim 11, wherein the method comprises:
providing a motion profile for the stage to a controller which controls an illumination source to illuminate the field of view of the camera; and
the controller which controls the illumination source providing the uniform response profile for each of the analysis signals by continuously modulating intensity of the illumination source based on speed of the stage when the stage is accelerating relative to the field of view of the camera and when the stage is decelerating relative to the field of view of the camera.

13. The method of claim 11, wherein:
the method comprises measuring a position of the stage using an encoder during periods comprising the first period and the third period; and
illuminating the field of view of the camera at the first and third average intensities during the first and third periods is based on providing measurements of the position of the stage from the encoder to a controller which controls an illumination source and modulates illumination intensity based on measurements of the position of the stage from the encoder.

14. The method of claim 11, wherein:
the first average intensity, the second average intensity and the third average intensity are all equal; and
the method comprises generating the set of analysis signals by performing acts comprising, for each exposure of features of the sample container on the stage, normalizing data from that exposure based on a speed of the stage when that exposure is captured.

15. The method of claim 11, wherein:
the camera is a time delay integration (TDI) line scan camera; and
illuminating the field of view of the camera during the first period, the second period and the third period is performed using an illumination source selected from a group consisting of:
a diode laser; and
a light emitting diode.

16. The method of claim 11, wherein:
the first period is comprised by an acceleration period during which the stage is accelerated relative to the field of view of the camera from immobility to the predetermined scanning speed;
the third period is comprised by a deceleration period during which the stage is decelerated relative to the field of view of the camera from the predetermined scanning speed to immobility;
the method comprises performing the set of non-uniform movement imaging acts a plurality of times, with each performance of the set of non-uniform movement imaging acts corresponding to a swath of features on the sample container;
during each performance of the set of non-uniform movement imaging acts, the stage is moving relative to the field of view of the camera in a scanning direction; and
the method comprises, between any two consecutive performances of the set of non-uniform movement imaging acts, moving from a swath corresponding to a first performance from the two consecutive performances to a swath corresponding to a second performance from the two consecutive performances by moving the stage in a direction oblique to the scanning direction.

17. The method of claim 11, wherein the method comprises focusing the camera based on exposures of features of the sample container on the stage captured during the first period.

18. The method of claim 11, wherein:
a product of the first average intensity and an average speed during the first period is equal to a product of the predetermined scanning speed and the second average intensity; and
a product of the third average intensity and an average speed during the third period is equal to the product of the predetermined scanning speed and the second average intensity.

19. The method of claim 11, wherein:
the first period is comprised by an acceleration period during which the stage is accelerated relative to the field of view of the camera from immobility to the predetermined scanning speed; and
the set of non-uniform movement imaging acts comprises illuminating the field of view of the camera at the first average intensity during the first period by providing an illumination source illuminating the field of view of the camera current continuously during the acceleration period at levels which vary with speed of the stage during the acceleration period.

20. The method of claim 11, wherein:
the first period is comprised by an acceleration period during which the stage is accelerated relative to the field of view of the camera from immobility to the predetermined scanning speed; and
the set of non-uniform movement imaging acts comprises illuminating the field of view of the camera at the first average intensity during the first period by providing an illumination source illuminating the field of view of the camera current in pulses at a rate which varies with the speed of the stage during the acceleration period.
